(19) United States
(12) Patent Application Publication
(10) Pub. No.: US 2025/0217441 A1
(43) Pub. Date: Jul. 3, 2025

(54) NEURAL NETWORK ACCELERATOR, NEURAL NETWORK ACCELERATION METHOD, AND MIXED-LENGTH VECTOR PRUNING METHOD FOR TRANSFORMER NEURAL NETWORK

(71) Applicant: POSTECH RESEARCH AND BUSINESS DEVELOPMENT FOUNDATION, Pohang-si (KR)

(72) Inventors: Youngjoo LEE, Pohang-si (KR); Eunji YOO, Pohang-si (KR); Gunho PARK, Pohang-si (KR)

(73) Assignee: POSTECH RESEARCH AND BUSINESS DEVELOPMENT FOUNDATION, Pohang-si (KR)

(21) Appl. No.: 18/617,362

(22) Filed: Mar. 26, 2024

(30) Foreign Application Priority Data
Dec. 28, 2023 (KR) 10-2023-0195569

(51) Int. Cl. G06F 17/16; G06F 7/50; G06F 7/544

(52) U.S. Cl. CPC G06F 17/16; G06F 7/50; G06F 7/5443

(57) ABSTRACT

A neural network operation acceleration apparatus may comprise: a memory storing a mask matrix obtained by a first pruning process for a weight matrix of each layer of a transformer neural network; a plurality of reconfigurable processing elements performing multiply-and-accumulate (MAC) operations on the weight matrix to which the mask matrix is applied and the input of each layer; and a local adder tree summing the operation outputs of adjacent processing elements selectively based on direction strength information obtained by analyzing the mask matrix.

### CROSS-REFERENCE TO RELATED APPLICATIONS

This application claims priority to Korean Patent Application No. 10-2023-0195569, filed on Dec. 28, 2023, with the Korean Intellectual Property Office (KIPO), the entire contents of which are hereby incorporated by reference.

### BACKGROUND

### 1. Technical Field

The present disclosure relates to a method for pruning a weight matrix used in neural network operations, a method for accelerating neural network operations with the results of pruning applied on hardware, and a hardware accelerator for the same.

### 2. Related Art

The content presented in this section serves solely as background information for the embodiments and does not represent any conventional technology.

Various types of neural networks are used in artificial intelligence technology fields such as speech recognition, image recognition, and machine translation.

Neural network is composed of multiple layers, each containing many interconnected neurons that communicate through synapses.

Each synapse has a weight assigned to it, and a matrix of these weights arranged in rows and columns is called a weight matrix.

The weights that constitute the weight matrix are determined in advance through the learning process.

Various techniques are being developed to reduce the data size of the weight matrix in order to alleviate memory load.

For example, the weight pruning technique can be applied to make some weights in the weight matrix 0.

In a pruned weight matrix, weights that are 0 do not actually affect the calculation results, so loading them into memory or transferring them to the processing element (PE) lowers the utilization of the processing element and causes inefficiency.

### SUMMARY

Currently, fine-grained pruning techniques are known to be used for lightweighting deep learning models, such as convolutional neural network (CNN), Vanilla Transformer, and bidirectional encoder representations from transformers (BERT).

However, the conventional techniques require a large amount of indexing memory and increase the complexity of the operation schedule because they implement the deep neural network (DNN) accelerator in a way that is not hardware-friendly. This poses challenges for hardware implementation due to the need for a large area and high power consumption.

The present disclosure has been conceive to solve the problems of conventional techniques by proposing an efficient lightweight method using structured vector pruning optimized for the characteristics of transformer neural networks and by proposing a sparsity-aware accelerator architecture.

The present disclosure also proposes a sparsity-aware transformer neural network operation accelerator that applies mixed-length vector pruning, which explores the trade-off of maximizing the structural size while not significantly degrading the model performance based on the observed weight masking pattern.

The present disclosure also proposes a transformer accelerator including memory and operation parts. The transformer accelerator can use on-chip memory to store unpruned weights, inputs, and various indexing information.

The present disclosure proposes an efficient sparsity-aware transformer accelerator by increasing the utilization of multiply-and-accumulate (MAC) operations on the accelerator hardware.

According to a first exemplary embodiment of the present disclosure, a neural network operation acceleration apparatus may comprise: a memory storing a mask matrix obtained by a first pruning process for a weight matrix of each layer of a transformer neural network; a plurality of reconfigurable processing elements performing multiply-and-accumulate (MAC) operations on the weight matrix to which the mask matrix is applied and the input of each layer; and a local adder tree summing the operation outputs of adjacent processing elements selectively based on direction strength information obtained by analyzing the mask matrix.

The local adder tree may be controlled to selectively sum the operation outputs of a predetermined number of adjacent processing elements among the plurality of reconfigurable processing elements according to the vector length obtained based on the direction strength information.

The vector length may be determined based on the strength of a horizontal vector in the direction strength information, and the predetermined number of adjacent processing elements of which the operation outputs are summed may be determined based on the vector length.

The neural network operation acceleration apparatus may further comprise a global adder tree accumulating partial sums for a row to output a final operation result for the row.

The plurality of processing elements may provide either a vertical MAC operation mode or a horizontal MAC operation mode based on a vertical or horizontal weight vector obtained based on the sparsity information obtained by analyzing the mask matrix.

In horizontal MAC operation mode, a value stored in a partial sum buffer may be updated by summing the MAC operation results of a plurality of consecutive inputs, among the inputs of each layer, and a plurality of horizontal weights with the current value of the partial sum buffer.

In vertical MAC operation mode, values stored in a plurality of partial sum buffers may be updated by summing the MAC operation results of one input of each layer and a plurality of vertical weights with the current values of the plurality of partial sum buffers.

The neural network operation acceleration apparatus may further comprise a global buffer storing a plurality of inputs corresponding to a single location index to provide a search window for finding valid input-weight pairs.

Each of the plurality of reconfigurable processing elements may include a plurality of MAC operators performing MAC operations in parallel.

The weight matrix to which the mask matrix is applied may be obtained by the Hadamard product between the weight matrix and the mask matrix.

According to a second exemplary embodiment of the present disclosure, a neural network acceleration method may comprise: acquiring, by a processor executing at least one instruction, a mask matrix through a first pruning process for a weight matrix of each layer of a transformer neural network; performing, by a plurality of reconfigurable processing elements, a multiply-and-accumulate (MAC) operations on the weight matrix to which the mask matrix is applied and the input of each layer; and summing, by a local adder tree, the operation outputs of adjacent processing elements selectively among the plurality of reconfigurable processing elements based on direction strength information obtained by analyzing the mask matrix.

The neural network acceleration method may further comprise: determining a vector length based on the strength of a horizontal vector obtained based on the direction strength information; and determining a predetermined number of adjacent processing elements of which the operation outputs are summed based on the vector length.

The neural network acceleration method may further comprise: outputting, by a global adder tree, a final operation result of a row by accumulating partial sums for the row.

The performing of MAC operations by the plurality of reconfigurable processing elements may comprise: performing the MAC operations according to a vertical or horizontal MAC operation mode based on a vertical or horizontal weight vector obtained based on the sparsity information obtained by analyzing the mask matrix.

The weight matrix to which the mask matrix is applied may be obtained by the Hadamard product between the weight matrix and the mask matrix.

According to a third exemplary embodiment of the present disclosure, a mixed-length vector pruning method of a transformer neural network may comprise: acquiring weights of a pre-trained transformer neural network; acquiring a mask matrix by performing a first pruning on the weights; acquiring direction strength information by analyzing the mask matrix; and acquiring a vector length based on the strength of a horizontal vector based on the direction strength information.

The acquiring of the direction strength information may comprise: acquiring vertical and horizontal direction strengths.

The method may further comprise: performing an inference process using the Hadamard product of a weight matrix representing the weights of the pre-trained transformer neural network and the mask matrix.

The method may further comprise: retraining the pre-trained transformer neural network based on the error of the inference results obtained by applying pruning based on the vector length to the pre-trained transformer neural network being equal to or greater than a threshold.

The method may further comprise: determining hardware scheduling for the multiply-and-accumulate (MAC) operations of the inputs and pruned weights of the pre-trained transformer neural network based on the vector length acquired in a layer-wise manner; and performing inference on the inputs for each layer according to the scheduling, wherein the acquiring of weights, the acquiring of a mask matrix, the acquiring of direction strength information, and the acquiring of vector length are performed in a layer-wise manner on the transformer neural network.

According to an embodiment of the present disclosure, a higher pruning ratio can be applied compared to the conventional head level pruning techniques while still maintaining performance within an acceptable range of degradation.

According to an embodiment of the present disclosure, the hardware complexity and hardware area can be reduced at the same pruning ratio by increasing the utilization of the MAC operator.

According to an embodiment of the present disclosure, the effects of reducing accelerator power consumption and hardware area can be more pronounced when applied to transformer neural networks targeted for hyper-scale AI implementation, such as LLM.

### BRIEF DESCRIPTION OF DRAWINGS

FIG. 1 is a conceptual diagram illustrating a layer structure of a transformer model with pruning applied according to an embodiment of the present disclosure.

FIG. 2 is a conceptual diagram illustrating the results of pruning direction analysis using a mask matrix of a multi-head attention model pruned according to an embodiment of the present disclosure.

FIG. 3 is a conceptual view illustrating the results of pruning direction analysis using a mask matrix of the pruned feed-forward network according to an embodiment of the present disclosure.

FIG. 4 is a conceptual diagram illustrating the structure of a sparsity-aware transformer neural network accelerator according to an embodiment of the present disclosure.

FIG. 5 is a flowchart illustrating a mixed-length vector pruning (MVP) method and a sparse matrix scheduling process using the method according to an embodiment of the present disclosure.

FIG. 6 is a conceptual diagram illustrating the process of mixed-length vector pruning and the intermediate results of the process according to an embodiment of the present disclosure.

FIG. 7 is a graph illustrating the direction strength of a GPT-2 small model derived from mixed-length vector pruning according to an embodiment of the present disclosure.

FIG. 8 is a graph illustrating the direction strength of a BERT base model derived from mixed-length vector pruning according to an embodiment of the present disclosure.

FIG. 9 is a conceptual diagram illustrating the horizontal mode of the dual-mode MAC operator within the processing elements of the sparsity-aware transformer neural network accelerator according to an embodiment of the present disclosure.

FIG. 10 is a conceptual diagram illustrating the vertical mode of the dual-mode MAC operator within the processing elements of the sparsity-aware transformer neural network accelerator according to an embodiment of the present disclosure.

FIG. 11 is a conceptual diagram illustrating the configuration of a local adder tree in the sparse-aware transformer neural network accelerator according to an embodiment of the present disclosure.

FIG. 12 is a graph illustrating the experimental results of mixed-length vector pruning and sparsity-aware transformer neural network accelerator according to an embodiment of the present disclosure.

FIG. 13 is a conceptual diagram illustrating an example of a generalized neural network operation device, a weight pruning device for neural network operations, a memory operation device for neural network operations, a memory interface control device for neural network operations, a scheduler for neural network operations, or a computing system that can perform at least part of the processes of FIGS. 1 to 12.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, even a technology known before the filing date of the present application may be included as a part of the configuration of the present disclosure when necessary, and will be described herein without obscuring the spirit of the present disclosure. However, in describing the configuration of the present disclosure, the detailed description of a technology known before the filing date of the present application that those of ordinary skill in the art can clearly understand may obscure the spirit of the present disclosure, and thus a detailed description of the related art will be omitted.

The present disclosure may leverage existing technologies involving accelerators for speeding up transformer neural network computations, lightweighting techniques for reducing neural network operations, pruning techniques, among others, known prior to the filing of this application, and at least part of these known technologies may be applied as essential elements for implementing the present disclosure. For example, descriptions of technologies necessary for implementing a part of the configuration of the present disclosure may be substituted by reference to Korean Published Patent Application No. 10-2019-0128795 entitled “Method of formatting weight matrix, accelerator using formatted data, and system including the same”, which is known to those skilled in the art.

However, the present disclosure does not intend to claim rights over these known technologies, and the contents of these known technologies may be incorporated as part of the present disclosure within the scope that aligns with the purpose of the present disclosure.

Hereinafter, preferred embodiments of the present disclosure are described with reference to the accompanying drawings in detail. In order to facilitate a comprehensive understanding of the present disclosure, the same reference numerals are used for identical components in the drawings, and redundant explanations for the same components are omitted.

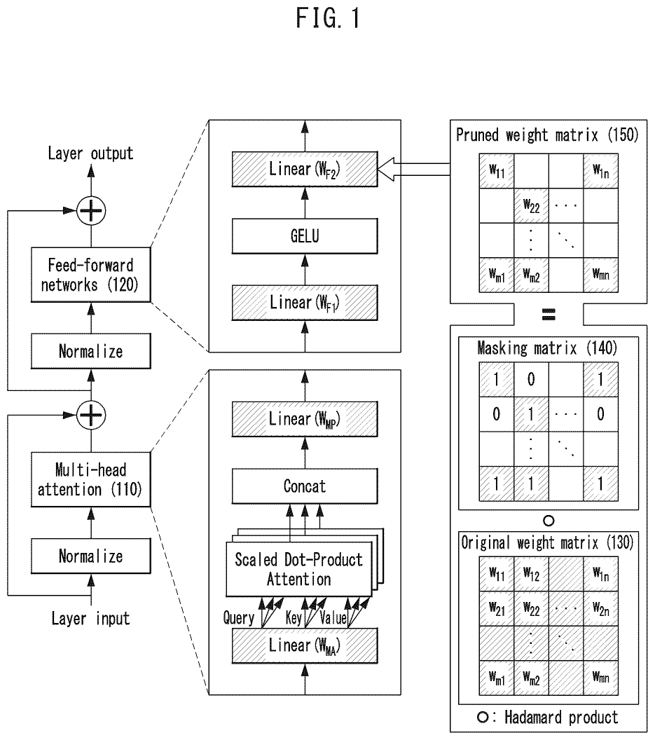

FIG. 1 is a conceptual diagram illustrating a layer structure of a transformer model with pruning applied according to an embodiment of the present disclosure.

In an embodiment of the present disclosure, the location of unpruned weights (weights that remain after pruning) may be analyzed to find an appropriate pruning structure in neural network models such as generative pre-trained transformer (GPT) or BERT, which are generative language models of the transformer family.

An embodiment of the present disclosure may provide a sparsity-aware transformer accelerator applying mixed-length vector pruning by exploring a trade-off maximizing the structure size while maintaining performance within an acceptable range based on observed weight masking patterns.

According to an embodiment of the present disclosure, each layer input is normalized and then passed to a multi-head attention 110 as shown in FIG. 1. The information passed through the multi-head attention 110 is then normalized and passed through a feed-forward network 120 to provide the output of the layer.

Here, the multi-head attention weights (Weight_Multi-head_attention, WMA), multi-head projection weights (Weight_Multi-head_projection, WMP), and two FFN weights (WF1 and WF2) may be provided to linear layers in the form of a pruned weight matrix 150 by the Hadamard product of the pre-trained weight matrix 130 and the mask matrix 140.

The mask matrix 140 masks weights with low importance to 0. Therefore, in the pruned weight matrix 150 obtained by the Hadamard product, the weights with low importance are removed as 0s, allowing for its application as a lightweight model.

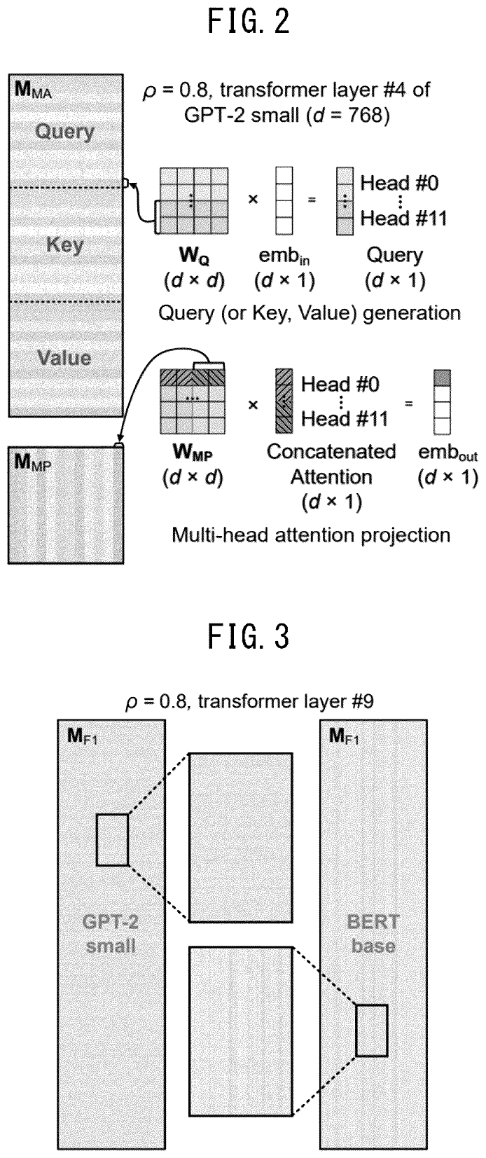

FIG. 2 is a conceptual diagram illustrating the results of pruning direction analysis using a mask matrix of a multi-head attention model pruned according to an embodiment of the present disclosure.

In an embodiment of the present disclosure, an existing fine-grained mask matrix based on motion-based pruning is used to analyze the unique mask pattern of a neural network and to determine the pruning structure as shown in FIG. 2. The fine-grained pruning pattern is predominantly observed in the horizontal and vertical directions for the attention Q, K, V, and projection. The observed patterns are considered reasonable results due to the characteristics of the processing steps of the multi-head attention operation.

Assuming that the basic matrix size is d, the matrix dimensions may be represented as 3d×d, d×d, 4d×d, and d×4d, respectively. The sparsity of pruned weights achieved through fine-tuning is known as a method to reduce model complexity while maintaining the accuracy of the original model.

In an embodiment of the present disclosure, the first pruning process for a weight matrix 130 of a pre-trained transformer neural network may be implemented by a known pruning technique such as fine-tuning.

In an embodiment of the present disclosure, the mask matrices of the respective weight matrices in the multi-head attention 110 may be represented as MMA∈{0, 1}^{3d×d} and MMP∈{0, 1}^{d×d}, and the mask matrices of the respective weight matrices in the feed-forward network 120 may be represented as MF1∈{0, 1}^{4d×d} and MF2∈{0, 1}^{d×4d}.

FIG. 3 is a conceptual view illustrating the results of pruning direction analysis using a mask matrix of the pruned feed-forward network according to an embodiment of the present disclosure.

In the feed-forward network 120, when observing the masking patterns of different transformer models such as GPT-2 and BERT, GPT-2 exhibits a horizontal pattern, whereas BERT exhibits a vertical pattern.

These masking patterns may be affected by the function and characteristics of the neural network model. For example, GPT-2 may be used in the token generation process that induces a row-wise pattern, and BERT may be used in the token selection process that creates a column-wise pattern.

With reference to FIGS. 2 and 3, for a given pruning ratio ρ, fine-grained pruning provides the closest accuracy to the original unpruned network, and increasing the size of structured pruning (which could signify vector size) may potentially degrade model accuracy.

When vector pruning (structured pruning) is applied with unoptimized operation scheduling, the model accuracy may be degraded even with the same pruning ratio.

FIG. 2 visualizes the masking patterns of pruned GPT-2 (ρ=0.8) for MMA and MMP. The pruning pattern of fine-grained MMA shows a dominant horizontal component, while the pruning pattern of fine-grained MMP shows a dominant vertical component.

The pruned weight matrix WMA (containing the remaining weights after pruning) may be implemented by vertically stacking three internal d×d query (WQ), key (WK), and value (WV) matrices that contain a plurality of heads corresponding to the horizontal strides of MMA.

The masking pattern MMP may have vertical strides, as the strong attention parts emphasize the corresponding columns of WMP during the training phase.

FIG. 3 visualizes the patterns of the mask matrix MF1 according to the type of FFN 120.

Different patterns emerge for the two different types of transformer models, GPT-2 and BERT. In this case, GPT-2 may have a horizontal component, and BERT may have a vertical component.

The weight matrix WF1 of GPT-2 may be used conceptually in the token generation step to induce row-wise patterns in MF1. The weight matrix WF1 of BERT fundamentally performs the token selection process, which may form column-wise patterns in the mask matrix MF1.

Although not illustrated in FIGS. 2 and 3, both pruned GPT-2 and BERT models are observed to exhibit vertically aligned masking patterns because the last weight matrix WF2 in MF2 is used to generate each element of the output embedding vector from a column-wise weighted sum.

In an embodiment of the present disclosure, pruning may be performed by selecting an optimized mixed-length vector for each weight layer of the transformer based on the masking patterns analyzed in FIGS. 2 and 3.

In order to find the dominant pruning direction of the mask matrix of each fine-grained layer, the present disclosure may propose a means for quantitatively evaluating the direction strength of the mask matrix.

In this case, m_{xy} may be represented as a binary element in the xth row and yth column of the given u*v mask matrix M. The direction strength s may be calculated as s=S_{V}−S_{H}, where S_{V} and S_{H} represent the vertical and horizontal strengths, respectively.

$${S}_{V} = \frac{1}{v} {\sum }_{j = 0}^{v - 1} {\sum }_{k = 0}^{u - 1} {( {m}_{kj} - \frac{1}{u} {\sum }_{i = 0}^{u - 1} {m}_{ij} )}^{2} \\ {S}_{H} = \frac{1}{u} {\sum }_{i = 0}^{u - 1} {\sum }_{l = 0}^{v - 1} {( {m}_{il} - \frac{1}{v} {\sum }_{j = 0}^{v - 1} {m}_{ij} )}^{2} \qquad [ Equation 1 ]$$

In an embodiment of the present disclosure, to compute the direction strength, the strength of each direction may be calculated first. S_{V} may be interpreted as the average of the vertical variances. The maximum vertical variance may be observed when half of the elements of the weight matrix survive, and the variance may decrease when there is an imbalanced weight distribution with more 1s (or 0s) in a column.

Similarly, S_{H} may be interpreted as the average variance of the uth row in the mask matrix. Although the variance-based direction strength cannot accurately represent the detailed pruning structure, it may explicitly express whether a line-shaped pattern occurs.

The direction strength s may be easily obtained using the statistical information of the fine-grained pruning pattern without requiring complex calculations and may intuitively represent the direction of the dominant pattern and the tendency of the line-shaped pattern by pruning the mask matrix M.

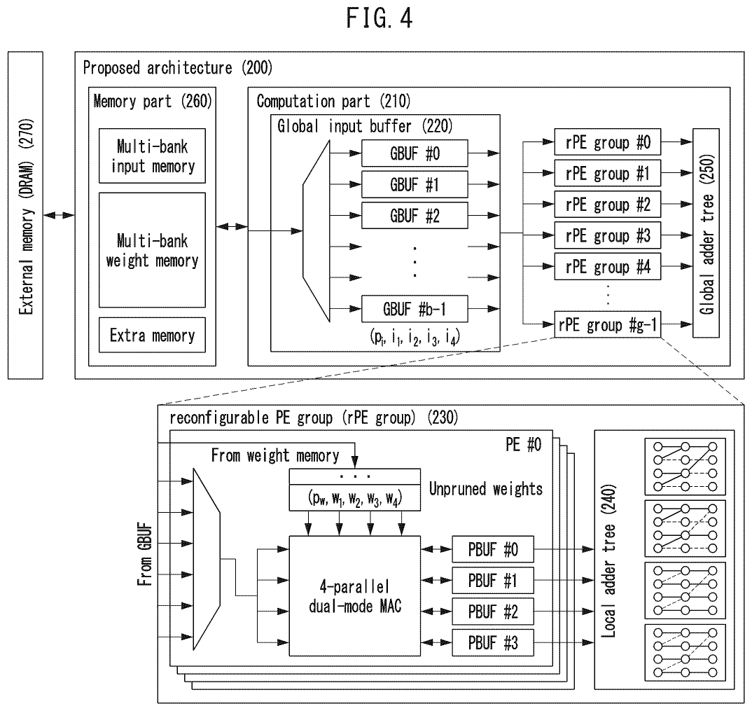

FIG. 4 is a conceptual diagram illustrating the structure of a sparsity-aware transformer neural network accelerator according to an embodiment of the present disclosure.

An embodiment of the present disclosure may provide an energy-efficient sparsity-aware transformer neural network accelerator through co-optimization of software algorithms and hardware.

An embodiment of the present disclosure may provide a sparsity-aware transformer neural network operation accelerator that applies mixed-length vector pruning, which explores the trade-off of maximizing the structural size while not significantly degrading the estimation performance based on the observed weight masking pattern.

An embodiment of the present disclosure can provide an architecture 200 of a transformer accelerator that includes a memory part 260 and a computation part 210. The transformer accelerator according to an embodiment of the present disclosure may use on-chip memory (memory part 260) capable of electronically communicate data with an external memory 270 to store unpruned weights, inputs, and various indexing information.

The computation part 210 of the accelerator may include a reconfigurable processing element (PE) group 230 for applying mixed-length vector pruning. In this case, the MAC operator may provide a vertical/horizontal dual mode and may include four parallel operators specialized for the structured pattern of mixed-length vector pruning.

In an embodiment of the present disclosure, offline weight scheduling for balanced processing scenarios may be adopted, utilizing a plurality of global input buffers 220 to compare position indicators and provide a search window for finding valid input pairs and weights. The global input buffer 220 may store a location indicator and four parameters together.

The hardware in FIG. 4 may be proposed as a hardware-friendly method combinable with mixed-length vector pruning. A sparsity-aware Transformer accelerator may be implemented with a structure incorporating a reconfigurable PE group 230 and a local adder tree 240.

An embodiment of the present disclosure can provide an efficient sparsity-aware transformer accelerator by increasing the utilization of multiply-and-accumulate (MAC) operations on the accelerator hardware.

In this case, the mask matrix may be obtained by operations performed on the server/host external to the proposed NPU, externally from a server/host, for example, through fine-tuning. The mask matrix may be stored in the memory part 260, and the calculation of the direction strength by the mask analysis process may be performed by a separate processing part (not shown) inside the NPU or by operations external to the NPU.

A neural network operation acceleration apparatus according to an embodiment of the present disclosure may include a memory for storing a mask matrix obtained by a first pruning process on the weight matrix of each layer of a transformer neural network, a plurality of reconfigurable processing elements performing multiply-and-accumulate (MAC) operations on the weight matrix to which the mask matrix is applied and the input of each layer, and a local adder tree 240 that selectively sums the operation outputs of adjacent processing elements based on the direction strength information obtained as a result of the analysis of the mask matrix.

The plurality of reconfigurable processing elements may be implemented by processing elements within a reconfigurable PE group 230. The mask matrix and the analysis information of the mask matrix may be stored in the extra memory in the memory part 260.

The local adder tree 240 may be controlled to selectively sum the operation outputs of a predetermined number of adjacent processing elements among the plurality of reconfigurable processing elements according to the vector length obtained based on the direction strength information.

The vector length may be determined based on the strength of the horizontal vector in the direction strength information. The predetermined number of adjacent processing elements whose operation outputs are summed may be determined based on the vector length.

According to an embodiment of the present disclosure, the neural network operation acceleration apparatus may further include a global adder tree 250 that accumulates partial sums for a single row and outputs the final operation result for the single row.

The plurality of processing elements may provide either a vertical MAC operation mode or a horizontal MAC operation mode based on a vertical or horizontal weight vector obtained based on the sparsity information obtained by analyzing the mask matrix.

According to one embodiment of the present disclosure, the neural network operation acceleration apparatus may update the value stored in the partial sum buffer by summing the MAC operation results of a plurality of consecutive inputs, among the inputs of each layer, and a plurality of horizontal weights in horizontal MAC operation mode with the current value of the partial sum buffer. Here, the update process may be part of the process of accumulating MAC operation results in the partial sum buffer.

According to an embodiment of the present disclosure, the neural network operation acceleration apparatus may update the values stored in a plurality of partial sum buffers by summing the MAC operation results of one input of each layer and a plurality of vertical weights in vertical MAC operation mode with the current values of the plurality of partial sum buffers. Here, the update process may be part of the process of accumulating MAC operation results in the partial sum buffer.

According to an embodiment of the present disclosure, the neural network operation acceleration apparatus may further include a global input buffer 220 that stores a plurality of inputs corresponding to a single location index to provide a search window for finding valid input-weight pairs.

Each of the plurality of reconfigurable processing elements may include a plurality of MAC operators that perform MAC operations in parallel.

According to an embodiment of the present disclosure, the neural network operation acceleration apparatus may obtain a weight matrix applied with a mask matrix by the Hadamard product between the weight matrix and the mask matrix.

The local adder tree 240 may be used to implement vector lengths of 4, 8, and 16 by selectively connecting the PEs to perform addition operations. The global adder tree 250 may derive the final result value for a single row by summing all the partial sums calculated by the local adder tree 240.

According to an embodiment of the present disclosure, the accelerator adopts offline weight scheduling to achieve a balanced processing scenario, and the global input buffer (GBUF) 220 may be utilized to implement a search window for finding valid input pairs (ix) and weight pairs (wx) by comparing location indicators Pi and Pw. Pi may denote a location indicator that indicates the position of the input, and Pw may denote a location indicator that indicates the position of the weight.

Meanwhile, ix may denote an input value, and x may denote an arbitrary number. The global input buffer 220 in FIG. 4 may include an input location indicator pi and four consecutive inputs i1, i2, i3, and i4. The weights input to the MAC operator may be pruned weights w1, w2, w3, and w4 identified by the weight location indicator pw.

In an embodiment of the present disclosure, a location indicator may be used to indicate the location of consecutive weight values pruned when a vector-based sparsity pattern is generated by mixed-length vector pruning (MVP).

In an embodiment of the present disclosure, it may be assumed that four consecutive inputs and/or consecutive weights are processed together. Considering the minimum vector size, the GBUF 220 may store one input position indicator pi and four inputs ix together, as shown in FIG. 4. In an embodiment, four ixs correspond to one pi may be understood to correspond to vector length=4. By setting up a larger number of GBUFs 220 than the comparative example that maps one ix to one pi for the same buffer size, the search window for reducing unwanted stalls that may occur due to locally imbalanced processing may be expanded, ultimately improving resource utilization.

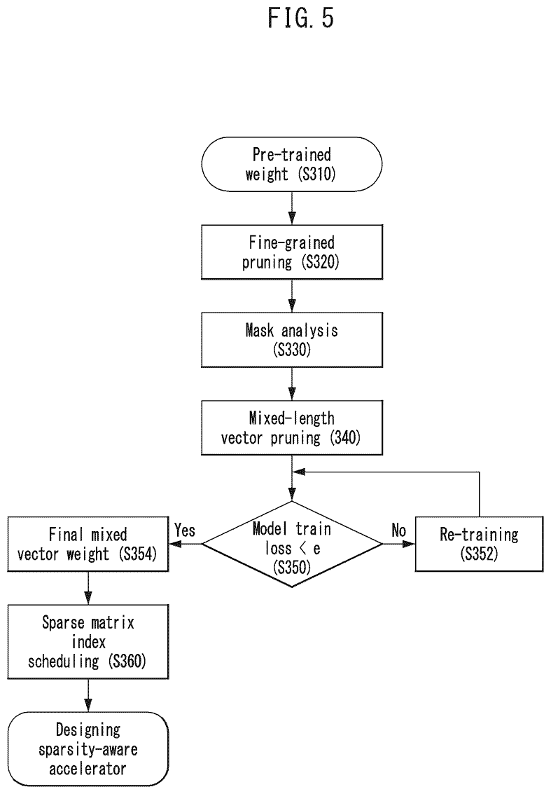

FIG. 5 is a flowchart illustrating a mixed-length vector pruning (MVP) method and a sparse matrix scheduling process using the method according to an embodiment of the present disclosure.

According to an embodiment of the present disclosure, the mixed-length vector pruning method for a transformer neural network may include acquiring the weights of a pre-trained transformer neural network at step S310, acquiring a mask matrix by performing a first pruning on the weights at step S320, analyzing the mask matrix at step S330 to acquire direction strength information at step S340, and acquiring a vector length based on the strength of the horizontal vector based on the direction strength information.

The acquiring of the direction strength information at step S340 may include obtaining both vertical direction strength and horizontal direction strength.

The mixed-length vector pruning method for a transformer neural network according to an embodiment of the present disclosure may further include performing an inference process (not shown) using the Hadamard product of a weight matrix representing the weights of a pre-trained transformer neural network and the mask matrix in pruning.

According to an embodiment of the present disclosure, the mixed-length vector pruning method for a transformer neural network may further include retraining the pre-trained transformer neural network at step S352 when the error of the inference results obtained by applying pruning based on the vector length to the pre-trained transformer neural network exceeds a threshold at step S350.

In the mixed-length vector pruning method for a transformer neural network according to an embodiment of the present disclosure, the acquiring of weights at step S310, the acquiring of a mask matrix at step S320, the acquiring of direction strength information at steps S330 and S340, and the acquiring of vector length may be performed in a layer-wise manner on the transformer neural network.

According to an embodiment of the present disclosure, the mixed-length vector pruning method for a transformer neural network may further include acquiring mixed-length vector weights based on the vector lengths obtained for each layer at step S354, determining hardware scheduling for the multiply-and-accumulate (MAC) operations of the inputs and pruned weights of the pre-trained transformer neural network at step S360, performing inference on the inputs for each layer according to the scheduling.

The mixed-length vector pruning method for a transformer neural network according to an embodiment of the present disclosure may perform fine-grained pruning at step S320 with the weights of a pre-trained neural network at step S310 and analyze, at step S330, the mask obtained as a result of the pruning process. Based on the analysis results of the mask, mixed-length vector pruning may be performed at step S340, and re-training may be conducted at step S352 until the model training loss value is less than a threshold e at step S350.

When the loss value is less than the threshold e, a fixed mixed-length vector weight may be obtained at step S354. Sparsity matrix index-based scheduling at step S360 allows for implementation of a high-efficiency transformer accelerator.

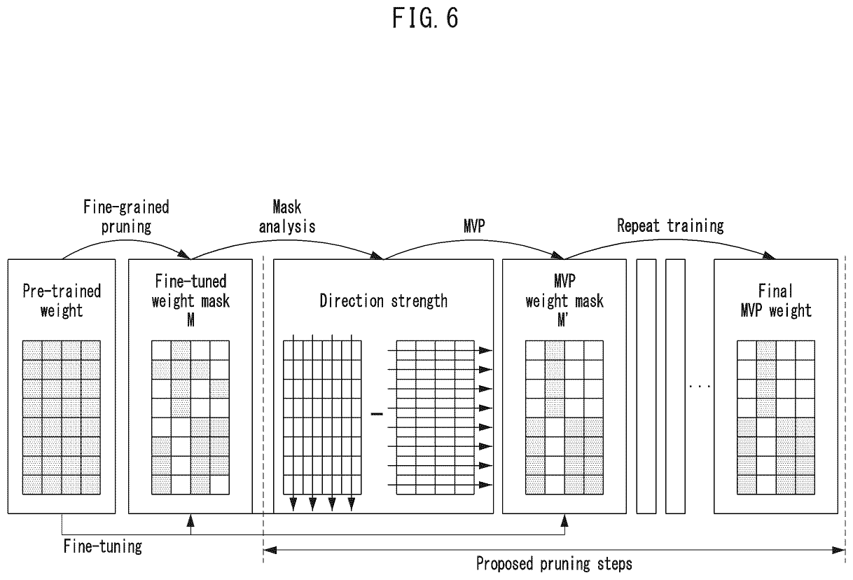

FIG. 6 is a conceptual diagram illustrating the process of mixed-length vector pruning and the intermediate results of the process according to an embodiment of the present disclosure.

Fine-grained pruning may be performed on pre-trained weights, resulting in a fine-grained weight mask M.

During pruning, masked elements may have a value of 0 while the rest may have a value of 1.

Mask analysis may yield the direction strength of the mask matrix M as horizontal/vertical components.

Mixed-length Vector Pruning (MVP) may generate a structured mask matrix M′, which has the same pruning ratio ρ as the fine-grained weight mask matrix M, by applying an appropriate threshold.

Internal pruning patterns may be represented as horizontal vectors of length l denoted as hl or vertical vectors of length l denoted as vl.

Pruning and retraining on the weight matrix using the new mask matrix M′ may recover model accuracy as close as possible to the original performance.

According to an embodiment of the present disclosure, an MVP technique capable of sufficiently reflecting the unique characteristics of weight matrices in each layer and a new pruning technique structured based on the MVP may be proposed.

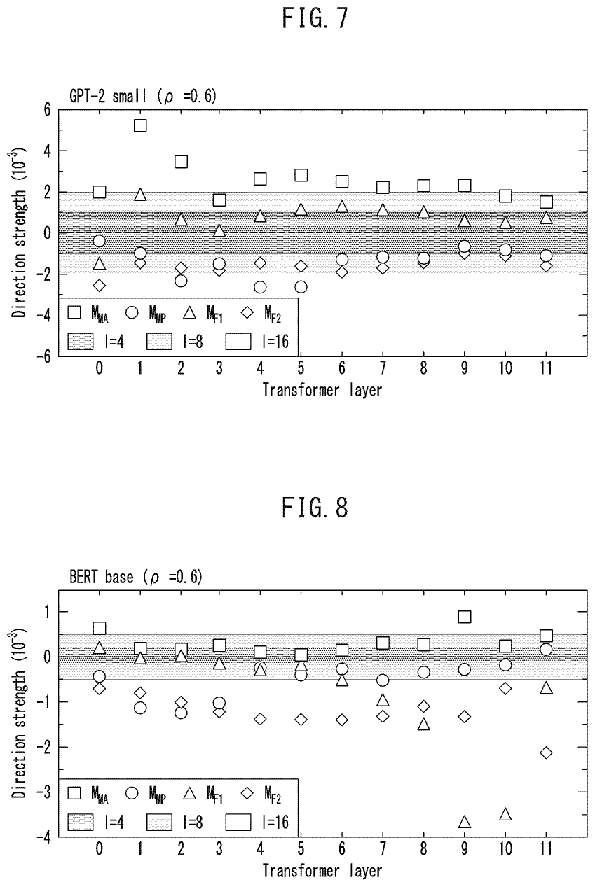

FIG. 7 is a graph illustrating the direction strength of a GPT-2 small model derived from mixed-length vector pruning according to an embodiment of the present disclosure.

FIG. 7 shows unique pruning directions of each mask matrix. Some mask matrices may be effective in the area where the vector length is l=4, while others may be effective in the area where the vector length is l=8, and yet others may be effective in the area where the vector length is l=16.

FIG. 8 is a graph illustrating the direction strength of a BERT base model derived from mixed-length vector pruning according to an embodiment of the present disclosure.

FIG. 8 shows unique pruning directions of each mask matrix. Some mask matrices may be effective in the area where the vector length is l=4, while others may be effective in the area where the vector length is l=8, and yet others may be effective in the area where the vector length is l=16.

With reference to FIGS. 7 and 8, when the direction strength of either vertical or horizontal is strong, effective pruning may occur at larger vector lengths (e.g., l=16).

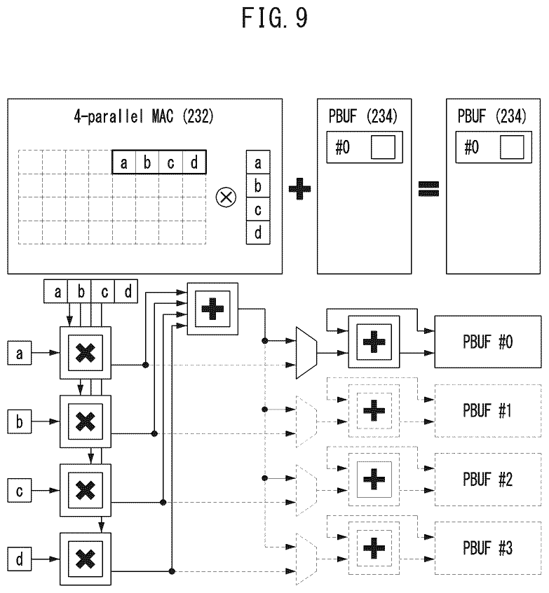

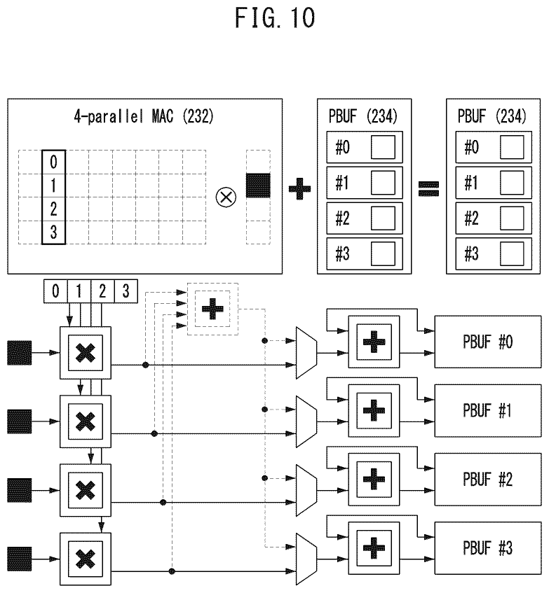

FIG. 9 is a conceptual diagram illustrating the horizontal mode of the dual-mode MAC operator 232 within the processing elements of the sparsity-aware transformer neural network accelerator according to an embodiment of the present disclosure.

According to one embodiment of the present disclosure, the neural network operation acceleration apparatus may update the value stored in the partial sum buffer (PBUF) 234 by summing the MAC operation results of a plurality of consecutive inputs, among the inputs of each layer, and a plurality of horizontal weights in horizontal MAC operation mode with the current value of the partial sum buffer 234. The process of updating the values stored in the partial sum buffer 234 may also be understood as the sequential accumulation of the results of MAC operations.

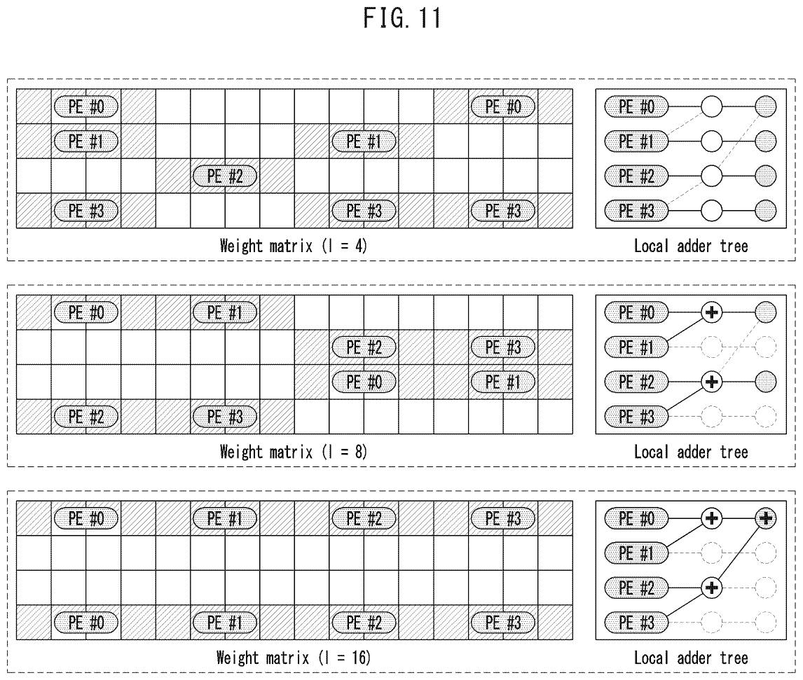

FIG. 10 is a conceptual diagram illustrating the vertical mode of the dual-mode MAC operator 232 within the processing elements of the sparsity-aware transformer neural network accelerator according to an embodiment of the present disclosure.

According to an embodiment of the present disclosure, the neural network operation acceleration apparatus may update the values stored in a plurality of partial sum buffers 234 by summing the MAC operation results of one input of each layer and a plurality of vertical weights in vertical MAC operation mode with the current values of the plurality of partial sum buffers 234. The process of updating the values stored in the partial sum buffer 234 may also be understood as the sequential accumulation of the results of MAC operations.

FIG. 11 is a conceptual diagram illustrating the configuration of a local adder tree in the sparse-aware transformer neural network accelerator according to an embodiment of the present disclosure.

The local adder tree may be controlled to selectively sum the operation outputs of a predetermined number of adjacent processing elements among the plurality of reconfigurable processing elements according to the vector length obtained based on the direction strength information.

The vector length may be determined based on a threshold set based direction strength information. The predetermined number of adjacent processing elements whose operation outputs are summed may be determined based on the vector length.

With reference to FIG. 4, four MAC operators are included within a single PE. When the vector size is 4 (l=4), the local adder tree may provide the outputs of the MAC operators and PBUF to the outside without any special changes.

When the vector size is 8 (l=8), the connection settings within the local adder tree may change (reconfigured by control signals), allowing the outputs of two adjacent PEs to be combined and forwarded (output) to the next stage.

When the vector size is 16 (l=16), the connection settings within the local adder tree may further change, allowing the outputs of four adjacent PEs to be combined and forwarded (output) to the next stage.

When the direction strength is very strong in one direction, the vector size (the size of structured pruning) may be maximized to 16.

When utilizing the local adder tree, the rPE group 230 may correspond to up to 16 consecutive vector-shaped weights.

Assuming that the vector size provided by MCP is optimized as the number of MAC operators increases (i.e., when the data to be processed by the neural network operation is larger), the MAC utilization value may be higher in the embodiment where 16 consecutive vector-shaped weights are processed compared to processing 4 or 8 consecutive vector-shaped weights.

As the number of MAC operators increases, leading to a higher number of PEs processed per cycle, and when an optimized vector size is provided by MVP, there may be a surplus margin in the bandwidth of the global input buffer in an embodiment where 16 consecutive vector-shaped weights are processed compared to processing 4 or 8 consecutive vector-shaped weights, thus reducing stalls during hardware operations due to the continuous distribution of residual weights.

According to an embodiment of the present disclosure, such structured processing method is capable of maximizing the load balancing effect of offline scheduling.

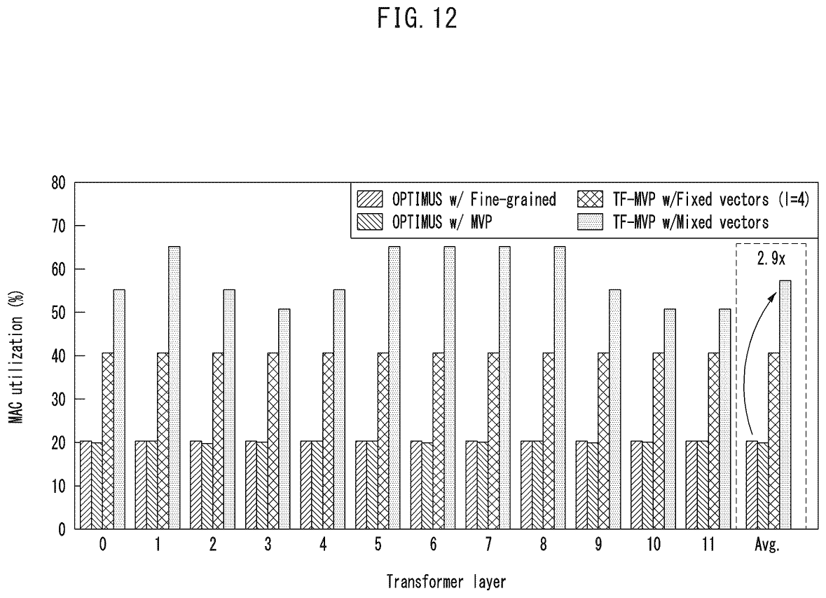

FIG. 12 is a graph illustrating the experimental results of mixed-length vector pruning and sparsity-aware transformer neural network accelerator according to an embodiment of the present disclosure.

With reference to FIG. 12, in the embodiment where the MVP of the present disclosure is combined with the existing OPTIMUS hardware, no performance improvement in MAC utilization is observed. In an embodiment where the MVP of the present disclosure is combined with the proposed TF-MVP accelerator architecture, a significant improvement in MAC utilization performance is observed compared to the embodiment utilizing existing technology.

In particular, the performance improvement in MAC utilization is more significant in the embodiment where mixed length vectors are applied than in the embodiment where the vector length is fixed at l=4.

When considering the performance degradation according to the pruning ratio, the embodiment of the present disclosure can achieve comparable or slightly better results than fine pruning when compared to the existing fine pruning technique.

An embodiment of the present disclosure can apply a higher pruning ratio while adjusting the performance degradation to an acceptable range compared to the existing head pruning technique.

Compared to the existing technique, an embodiment of the present disclosure can reduce hardware complexity and area while maintaining the same pruning ratio.

An embodiment of the present disclosure can significantly improve utilization compared to the existing technique by efficiently utilizing MAC operators.

An embodiment of the present disclosure can have a significant effect on reducing the power consumption and hardware area of an accelerator when targeting transformer neural networks for implementing hyper-scale AI such as LLM.

An embodiment of the present disclosure can provide mixed-length vector pruning optimized for the model by analyzing the fine-grained pruning mask results for efficient transformer accelerator operation.

An embodiment of the present disclosure can perform layer-wise model-optimized mixed-length vector pruning through direction strength analysis. In this case, mask analysis, direction strength calculation, vector pruning, and sparsity-aware scheduling can be performed for each layer.

In an embodiment of the present disclosure, direction strength and vector size may be calculated differently for each layer. An embodiment of the present disclosure can provide a sparsity-aware transformer accelerator through hardware-friendly mixed-length vector pruning.

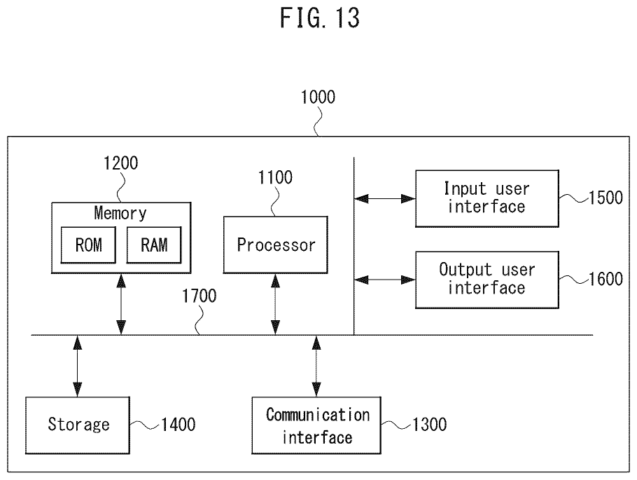

FIG. 13 is a conceptual diagram illustrating an example of a generalized neural network operation device, a weight pruning device for neural network operations, a memory operation device for neural network operations, a memory interface control device for neural network operations, a scheduler for neural network operations, or a computing system that can perform at least part of the processes of FIGS. 1 to 12.

For example, the accelerator architecture 200 shown in FIG. 4 may be implemented similar to the computing system in FIG. 13.

According to an embodiment of the present disclosure, at least part of the processes of mixed-length vector pruning, neural network operation acceleration, neural network operation, memory operation for neural network operations, and/or scheduling methods for neural network operations may be performed by the computing system 1000 of FIG. 13.

With reference to FIG. 13, the computing system 1000 according to an embodiment of the present disclosure may include a processor 1100, a memory 1200, a communication interface 1300, a storage device 1400, an input interface 1500, an output 1600, and a bus 1700.

The computing system 1000 according to an embodiment of the present disclosure may include at least one processor 1100 and a memory 1200 storing instructions for instructing the at least one processor 1100 to perform at least one step. At least some steps of the method according to an embodiment of the present disclosure may be performed by the at least one processor 1100 loading and executing instructions from the memory 1200.

The processor 1100 may refer to a central processing unit (CPU), a graphics processing unit (GPU), or a dedicated processor on which the methods according to embodiments of the present disclosure are performed.

Each of the memory 1200 and the storage device 1400 may be configured as at least one of a volatile storage medium and a non-volatile storage medium. For example, the memory 1200 may be configured as at least one of read-only memory (ROM) and random access memory (RAM).

Also, the computing system 1000 may include a communication interface 1300 for performing communication through a wireless network.

In addition, the computing system 1000 may further include a storage device 1400, an input interface 1500, an output interface 1600, and the like.

In addition, the components included in the computing system 1000 may each be connected to a bus 1700 to communicate with each other.

The computing system of the present disclosure may be implemented as a communicable desktop computer, a laptop computer, a notebook, a smart phone, a tablet personal computer (PC), a mobile phone, a smart watch, a smart glass, an e-book reader, a portable multimedia player (PMP), a portable game console, a navigation device, a digital camera, a digital multimedia broadcasting (DMB) player, a digital audio recorder, a digital audio player, digital video recorder, digital video player, a personal digital assistant (PDA), etc.

A neural network operation acceleration method according to an embodiment of the present disclosure may include acquiring, by a processor 1100 executing at least one instruction, a mask matrix through a first pruning process for weight matrices of each layer of a transformer neural network; performing, by a plurality of reconfigurable processing elements, a multiply-and-accumulate (MAC) operations on the weight matrices to which the mask matrix is applied and the input of each layer; and summing, by a local adder tree, the operation outputs of adjacent processing elements selectively among the plurality of reconfigurable processing elements based on direction strength information obtained by analyzing the mask matrix.

The neural network acceleration method according to an embodiment of the present disclosure may further include determining a vector length based on the strength of a horizontal vector obtained based on the direction strength information and determining a predetermined number of adjacent processing elements of which the operation outputs are summed based on the vector length.

The neural network acceleration method according to an embodiment of the present disclosure may further include outputting, by a global adder tree, a final operation result of a row by accumulating partial sums for the row.

The performing of MAC operations by the plurality of reconfigurable processing elements may include performing the MAC operations according to a vertical or horizontal MAC operation mode based on a vertical or horizontal weight vector obtained based on the sparsity information obtained by analyzing the mask matrix.

In the neural network acceleration method according to an embodiment of the present disclosure, the weight matrix to which the mask matrix is applied is obtained by the Hadamard product between the weight matrices and the mask matrix.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A neural network operation acceleration apparatus comprising:
a memory storing a mask matrix obtained by a first pruning process for a weight matrix of each layer of a transformer neural network;
a plurality of reconfigurable processing elements performing multiply-and-accumulate (MAC) operations on the weight matrix to which the mask matrix is applied and the input of each layer; and
a local adder tree summing the operation outputs of adjacent processing elements selectively based on direction strength information obtained by analyzing the mask matrix.

2. The neural network operation acceleration apparatus of claim 1, wherein the local adder tree is controlled to selectively sum the operation outputs of a predetermined number of adjacent processing elements among the plurality of reconfigurable processing elements according to the vector length obtained based on the direction strength information.

3. The neural network operation acceleration apparatus of claim 2, wherein the vector length is determined based on the strength of a horizontal vector in the direction strength information, and the predetermined number of adjacent processing elements of which the operation outputs are summed is determined based on the vector length.

4. The neural network operation acceleration apparatus of claim 1, further comprises a global adder tree accumulating partial sums for a row to output a final operation result for the row.

5. The neural network operation acceleration apparatus of claim 1, wherein the plurality of processing elements provides either a vertical MAC operation mode or a horizontal MAC operation mode based on a vertical or horizontal weight vector obtained based on the sparsity information obtained by analyzing the mask matrix.

6. The neural network operation acceleration apparatus of claim 5, wherein, in horizontal MAC operation mode, a value stored in a partial sum buffer is updated by summing the MAC operation results of a plurality of consecutive inputs, among the inputs of each layer, and a plurality of horizontal weights with the current value of the partial sum buffer.

7. The neural network operation acceleration apparatus of claim 5, wherein, in vertical MAC operation mode, values stored in a plurality of partial sum buffers are updated by summing the MAC operation results of one input of each layer and a plurality of vertical weights with the current values of the plurality of partial sum buffers.

8. The neural network operation acceleration apparatus of claim 1, further comprising a global buffer storing a plurality of inputs corresponding to a single location index to provide a search window for finding valid input-weight pairs.

9. The neural network operation acceleration apparatus of claim 1, wherein each of the plurality of reconfigurable processing elements includes a plurality of MAC operators performing MAC operations in parallel.

10. The neural network operation acceleration apparatus of claim 1, wherein the weight matrix to which the mask matrix is applied is obtained by the Hadamard product between the weight matrix and the mask matrix.

11. A neural network acceleration method comprising:
acquiring, by a processor executing at least one instruction, a mask matrix through a first pruning process for a weight matrix of each layer of a transformer neural network;
performing, by a plurality of reconfigurable processing elements, a multiply-and-accumulate (MAC) operations on the weight matrix to which the mask matrix is applied and the input of each layer; and
summing, by a local adder tree, the operation outputs of adjacent processing elements selectively among the plurality of reconfigurable processing elements based on direction strength information obtained by analyzing the mask matrix.

12. The neural network acceleration method of claim 11, further comprising:
determining a vector length based on the strength of a horizontal vector obtained based on the direction strength information; and
determining a predetermined number of adjacent processing elements of which the operation outputs are summed based on the vector length.

13. The neural network acceleration method of claim 11, further comprising outputting, by a global adder tree, a final operation result of a row by accumulating partial sums for the row.

14. The neural network acceleration method of claim 11, wherein the performing of MAC operations by the plurality of reconfigurable processing elements comprises performing the MAC operations according to a vertical or horizontal MAC operation mode based on a vertical or horizontal weight vector obtained based on the sparsity information obtained by analyzing the mask matrix.

15. The neural network acceleration method of claim 11, wherein the weight matrix to which the mask matrix is applied is obtained by the Hadamard product between the weight matrix and the mask matrix.

16. A mixed-length vector pruning method of a transformer neural network, the method comprising:
acquiring weights of a pre-trained transformer neural network;
acquiring a mask matrix by performing a first pruning on the weights;
acquiring direction strength information by analyzing the mask matrix; and
acquiring a vector length based on the strength of a horizontal vector based on the direction strength information.

17. The method of claim 16, wherein the acquiring of the direction strength information comprises acquiring vertical and horizontal direction strengths.

18. The method of claim 16, further comprising performing an inference process using the Hadamard product of a weight matrix representing the weights of the pre-trained transformer neural network and the mask matrix.

19. The method of claim 16, further comprising retraining the pre-trained transformer neural network based on the error of the inference results obtained by applying pruning based on the vector length to the pre-trained transformer neural network being equal to or greater than a threshold.

20. The method of claim 16, further comprising:
determining hardware scheduling for the multiply-and-accumulate (MAC) operations of the inputs and pruned weights of the pre-trained transformer neural network based on the vector length acquired in a layer-wise manner; and
performing inference on the inputs for each layer according to the scheduling,
wherein the acquiring of weights, the acquiring of a mask matrix, the acquiring of direction strength information, and the acquiring of vector length are performed in a layer-wise manner on the transformer neural network.
